(19) United States
(12) Patent Application Publication
(10) Pub. No.: US 2009/0144950 A1
(43) Pub. Date: Jun. 11, 2009

(54) CARABINER

(76) Inventor: James Blaine Archer, JR., Golden, CO (US)

Correspondence Address: HOLLAND & HART, LLP, P.O BOX 8749, DENVER, CO, 80201, US

(21) Appl. No.: 11/952,724

(22) Filed: Dec. 7, 2007

(51) Int. Cl. F16B 45/00

(52) U.S. Cl. 24/598.2

(57) ABSTRACT

A carabiner is provided with a generally C-shaped body that includes an elongated spine, an upper arm, and an elongated lower arm that is fixed in position with respect to the spine. First and second free ends of the C-shaped body are separated by a gap that may be selectively opened and closed by a gate, positioned generally opposite the spine. The lower arm is provided with a cross-sectional diameter that is larger than a cross-sectional diameter of the spine. Running grooves may be formed into the lower arm to receive lengths of rope in various positions. The lower arm may be formed to be hollow to assist in heat dissipation.

### BACKGROUND

Carabiners have been provided for use in various sports and activities requiring “ropework.” These sports and activities have included different forms of climbing, caving, sailing, and even general construction. One might even find carabiners at work in the commercial window washing industry. Around the home, a person might use one or more carabiners as anchoring points in hoisting articles to a ceiling for storage. The common designs of such carabiners have included locking and non-locking gates of various shapes and configurations. The bodies of the carabiners have been shaped as ovals, pears, D-shapes, offset D-shapes, and different combinations of such shapes.

Regardless of their shape, however, the carabiners have all been typically formed with opposite ends with curved surfaces to engage loops of rope, webbing, carabiners and other structures in a weight bearing fashion. Many times, the top or bottom portions of the carabiners have had to slidably engage lengths of rope, while supporting varied weights. Such sliding engagement creates friction, which can be beneficial for controlling the ascent or decent of an object supported by the carabiner. However, prior carabiners have been provided with lower or upper arms having relatively narrow diameters, creating an increased stress point on an area of rope engaged with the carabiner. In the case of a fall, the entire load, whether that of a human being, or a non-human load, must be absorbed by the small length of rope engaged with the relatively thin arm of the carabiner.

Moreover, when using a rope to lower a load, it is often desirable to increase, rather than decrease, friction. Small diameter support arms have typically failed to provide sufficient frictional engagement between the carabiners and lengths of rope in many uses. To address this, several knots have been developed, such as the Munter Hitch. Knots such as this provide adequate friction, but cause a great deal of stress and twisting on the rope, especially ropes that are comprised of two parts—an inner load bearing part, and an exterior protective sleeve. Even so, such frictional engagement, even that which has proven insufficient, produces heat that can decrease the useful life of the equipment being used.

Some prior art designs have attempted to resolve the shortcomings of the art by providing rollers to engage the lengths of rope as they move past the support arms of the carabiners. However, such rollers fail to address the issue of increasing friction. Rather, such rollers serve an opposite purpose by decreasing frictional engagement between the lengths of rope and the carabiners. Moreover, the rollers have been provided with narrow diameters, failing to address the issue of creating increased stress points on areas of rope engaged with the carabiner Such rollers, while helpful in certain limited instances, have only added moving parts, such as axles and retaining members that have increased maintenance and incidence of failure to previously simple carabiner designs.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A carabiner is provided with a body that includes a spine, an upper arm, and a lower arm. The upper arm may be longer or shorter than the lower arm. The body, in one aspect, is generally C-shaped, having first and second free ends that face one another, separated by a gap. A gate is provided that may be selectively moved between open and closed positions with respect to gap. In one aspect, the lower arm is provided to have a cross-sectional diameter that is larger than a cross-sectional diameter of the spine and may, in another aspect, be provided to have a cross-sectional diameter that is larger than a cross-sectional diameter of the upper arm as well.

In at least one embodiment, the lower arm of the carabiner is provided with a concave profile that is oriented to face toward the upper arm. The concave profile may be provided to extend in an annular fashion about a circumference of the lower arm. In either respect, the concave profile may be shaped and sized to provide a running groove to receive a length of rope. Multiple grooves may be provided to receive one or more lengths of rope in various positions. As the diameter of the lower arm increases, frictional engagement between lengths of rope along the running grooves will increase for uses that benefit therefrom. Additionally, as the diameter increases, the carabiner will provide additional surface area to absorb the stress of an increased load experienced during a fall, for example.

In another aspect, the lower arm of the carabiner may be formed with an open interior portion, extending along a long axis of said lower arm. This may reduce the weight of the carabiner and further provide for heat dissipation from frictional engagement between lengths of rope and the running grooves of the lower arm.

In at least one embodiment, the upper arm, lower arm and spine of the carabiner are oriented with respect to one another such that a majority of a weight supported by the lower arm is borne by the spine to increase the overall strength of the carabiner. Locking gates and other various gate configurations may be used with the carabiner to further increase overall strength.

These and other aspects of various embodiments of the present system will be apparent after consideration of the Detailed Description and Figures herein.

### BRIEF DESCRIPTION OF THE DRAWINGS

Non-limiting and non-exhaustive embodiments of the present system and method are described with reference to the following figures, wherein like reference numerals refer to like parts throughout the various views unless otherwise specified.

FIG. 1 depicts a front, elevation view of one contemplated embodiment of the carabiner;

FIG. 2 depicts a front elevation view of the carabiner depicted in FIG. 1 and further demonstrates one manner in which a rope may be engaged with the carabiner;

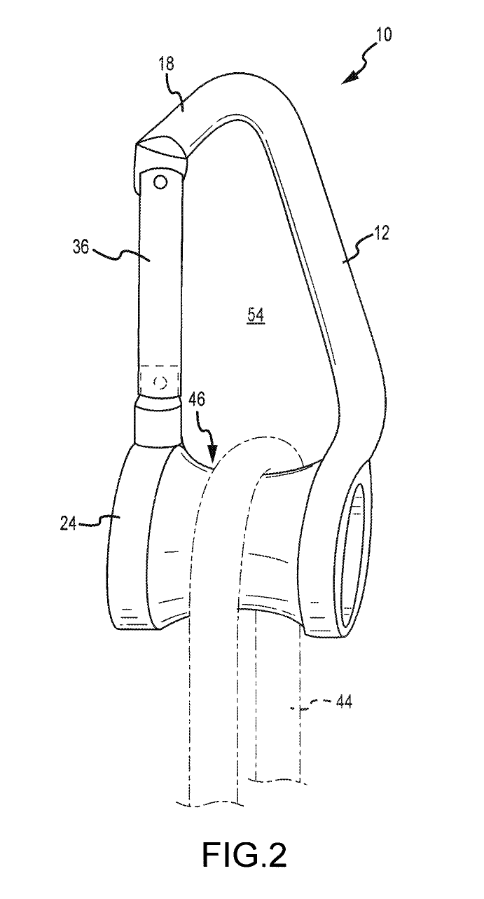

FIG. 3 depicts a front elevation view of the carabiner depicted in FIG. 1 and further demonstrates another manner in which a rope may be engaged with the carabiner;

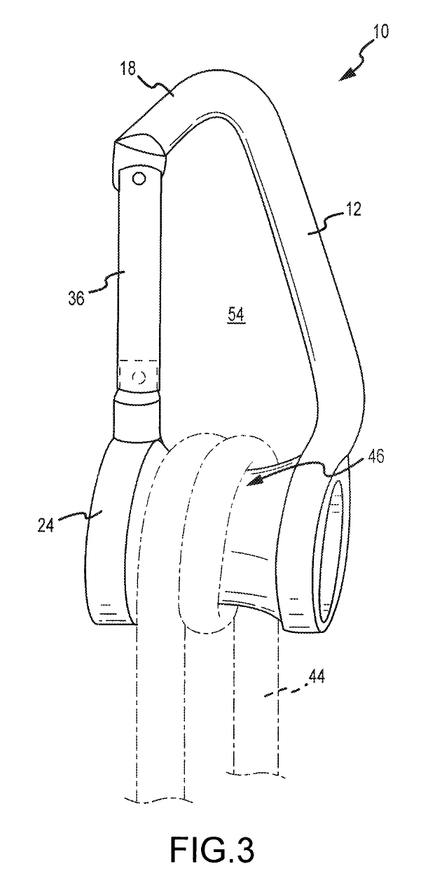

FIG. 4 depicts an elevation view of another contemplated embodiment of the carabiner;

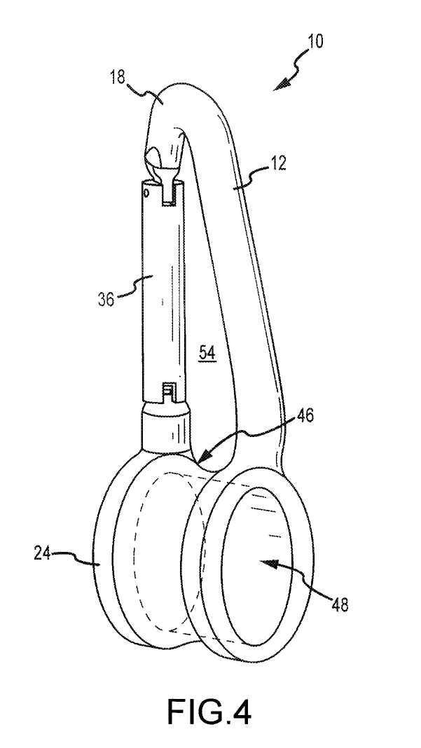

FIG. 5 depicts a front, elevation view of still another contemplated embodiment of the carabiner and further demonstrates one manner in which a rope may be engaged with the carabiner;

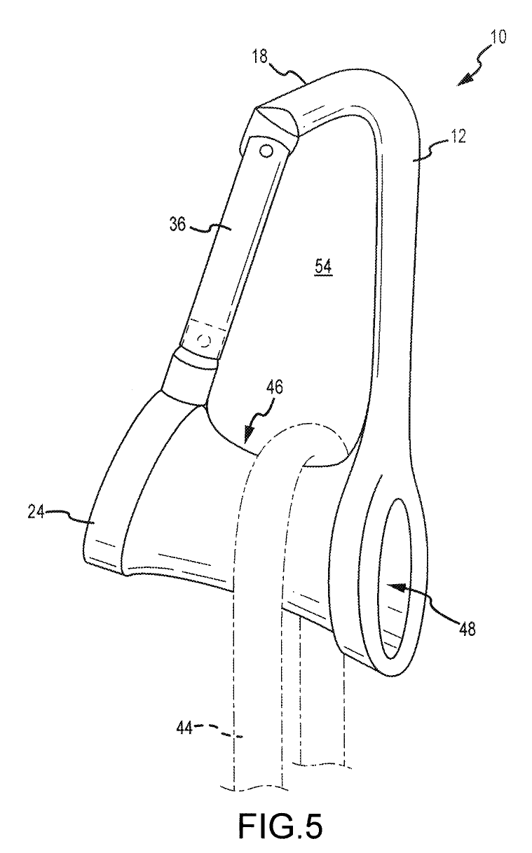

FIG. 6 depicts a front, elevation view of yet another contemplated embodiment of the carabiner; and

FIG. 7 depicts one manner in which the carabiner may be coupled with another carabiner to form a useful device.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the system and method. However, embodiments may be implemented in many different forms and should not be construed as being limited to the embodiments set forth herein. The following detailed description is, therefore, not to be taken in a limiting sense.

The carabiner 10 is generally provided with a spine 12, having an upper end portion 14 and a lower end portion 16. The spine 12 is generally depicted in the figures as being elongated and generally linear in nature. However, it is contemplated that, according to various design considerations that present themselves for different intended uses, the spine 12 may be provided in a non-linear fashion. The carabiner 10 is further provided with an upper arm 18, having an opposite first end portion 20 and second end portion 22. In one aspect, the first end portion 20 of the upper arm 18 is coupled with the upper end portion 14 of the spine 12. It is contemplated that these structures may be formed in a unitary construction fashion or coupled with one another using various known methods and structures. The carabiner 10 is further provided with a lower arm 24, having a first end portion 26 and an opposing second end portion 28. The first end portion 26 of the lower arm 24 may be formed in a unitary construction with the lower end portion 16 of the spine 12 or may be secured therewith using one of various known coupling methods and systems in the industry.

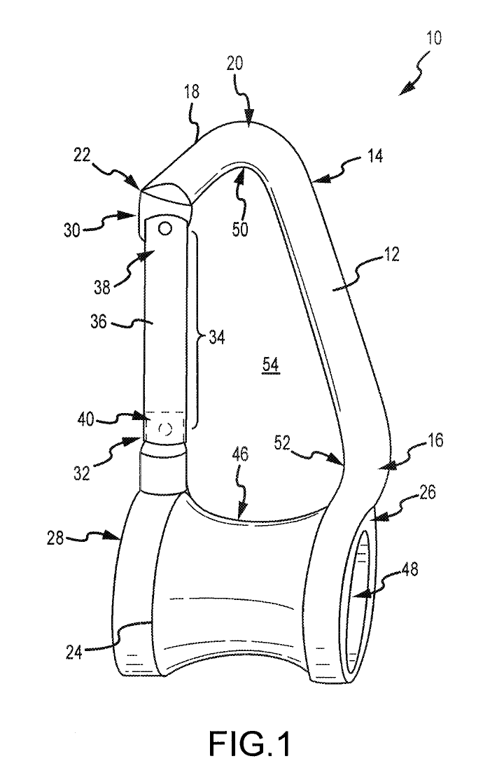

With reference to FIG. 1, it can be seen that, in at least one aspect, the body of the carabiner 10 may be generally C-shaped, terminating in a first free end portion 30 and a second free end portion 32. The opposing free end portions are axially disposed and separated from one another by a gap 34. A gate 36 may be used to selectively open and close the gap 34 when putting the carabiner 10 to use. It is contemplated that the gate 36 may be provided in one of various different forms. For example, the gate 36 may be provided in a non-locking fashion, whereby a pivot end portion 38 of the gate 36 is pivotably coupled with one of the first free end portion 30 or second free end portion 32; a free end portion 40 of the gate 36 may then be provided to releasably engage the opposing free end portion in a secure fashion. In one aspect, the gate 36 may be provided as a straight gate which will provide a relatively strong and inexpensive gate for the carabiner 10. In another aspect, the gate 36 may be provided as a bent gate, which provides a strength similar to that of a straight gate but allows items to be clipped and unclipped more easily from the carabiner 10. In still another aspect, the gate 36 may be provided as a wire gate, which will further reduce the overall weight of the carabiner 10 and provide fewer instances of “gate flutter,” a condition in which the gate 36 opens as a result of the momentum of a fall, for example.

In another embodiment, the gate 36 may be provided as a locking gate, which incorporates a locking sleeve 42 around the gate 36. Where the carabiner 10 is provided with a locking gate 36, it is contemplated that the gate 36 may have the same general shapes afforded by the non-locking gate 36, described previously. However, the locking feature may provide additional security against an unintentional opening of the carabiner 10 if, for example, the carabiner 10 is accidentally struck against a rock or becomes caught in a loop of rope. In one aspect, the locking sleeve 42 may be provided in an auto-locking fashion, which allows for quick locking and also prevents a user from forgetting to lock the carabiner. However, auto-locking gates may provide higher incidences of wear or failure. Accordingly, in another aspect, a twist or screw lock gate 36 may be provided, wherein the locking sleeve 42 is threadably engaged with a free end portion of the carabiner 10 in a manual fashion.

In at least one embodiment, the lower arm 24 is provided with a cross-sectional diameter that is larger than a cross-sectional diameter of the spine 12. Similarly, it is contemplated that one or more embodiments may provide for a lower arm 24 having a larger cross-sectional diameter than that provided for any other structural portion of the carabiner 10, including the upper arm 18 and the gate 36. In any case, the increased relative cross-sectional diameter will provide a greater relative circumferential surface area for the lower arm 24 by comparison with the remaining structures of the carabiner 10.

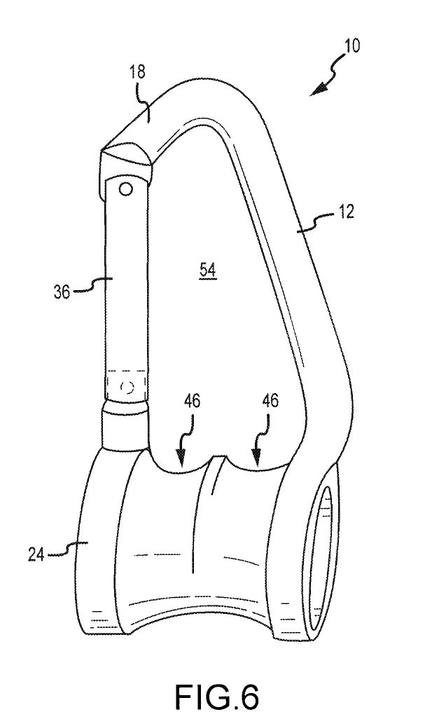

In one aspect, the lower arm 24 may be provided with a concave profile that is oriented to at least face toward the upper arm 18 of the carabiner 10. The concave profile, in one aspect, may be provided to extend in an annular fashion about a circumference of the lower arm 24, such as depicted in the figures. In at least one embodiment and with reference to FIG. 6, the lower arm 24 may be provided with a profile having a plurality of concave portions, positioned closely adjacent one another and oriented in a similar fashion to at least face toward the upper arm 18. In either respect, the concave portions of the profile afforded to the lower arm 24 may be shaped and sized to provide running grooves for one or more lengths of rope 44. As such, it is contemplated that the shape and size of each of the running grooves 46 may be provided to accommodate different rope thicknesses, according to the intended uses of the carabiner 10. It is further contemplated that the running grooves 46 may be provided in different shapes and sizes along the same lower arm 24 to accommodate various uses of the carabiner 10 as well as the engagement of different ropes of various sizes simultaneously.

It is contemplated that lengths of rope 44 may be placed into many different engagement positions with respect to the lower arm 24. For example, it is contemplated that a single length of rope 44 may be disposed along an upper surface of a single running groove 46 alone, allowing the opposing ends of rope to depend downwardly from the carabiner 10. In another example, a length of rope 44 may be disposed along both the upper and lower surfaces of a running groove 46, simultaneously, effectively wrapping around the lower arm 24 at least once. In still another example, the length of rope 44 may engage multiple running grooves 46 simultaneously as the length of rope 44 wraps around the circumference of the lower arm 24 more than once. In various contemplated uses of the carabiner 10, it is contemplated that, as the length of rope 44 is wound about the circumference of the lower arm 24 (partially, completely, or more than once), the length of rope 44 may be slid along the exterior surface of the lower arm 24, such as during a repelling or hoisting operation, for example. In these instances, the increase in relative cross-sectional diameter of the lower arm 24 will increase the frictional engagement between the lower arm 24 and the length of rope 44, providing a slower and more controlled moving engagement between the lower arm 24 and the length of rope 44 during ascending or descending engagement of the length of rope 44.

In at least one embodiment, it is contemplated that the lower arm 24 may be provided with an open interior portion 48 that extends along a long axis of the lower arm 24. It is contemplated that the open interior portion 48 may extend through the opposite end portions 26 and 28 of the lower arm 24. However, it is further contemplated that the open interior portion 48 may extend only partially along a length of the lower arm 24. Furthermore, the open interior portion 48 may be provided as a plurality of open interior portions within the open lower arm 24. In this manner, it is contemplated that the carabiner 10 may be provided with an enlarged lower arm 24 without significantly increasing the weight of the carabiner design.

It is contemplated that the carabiner 10 may be formed from a number of rigid materials that include aluminum, steel, various polymers and combinations of such materials. Where metals or other materials are used that provide a relatively high degree of heat conductivity, the open interior portion 48 will provide an improved level of heat dissipation to the lower arm 24 as frictional engagement occurs between lengths of rope 44 and the lower arm 24. This ability to dissipate heat will further compliment the heat-syncing abilities of the other structural members of the carabiner 10, such as the spine 12, when the carabiner 10 is formed from a heat conductive material.

It is contemplated that the carabiner 10 may be provided in various different shapes. For example, the carabiner 10 may be provided to resemble an oval, which may provide advantages of inexpensive manufacturing attributes. However, an oval shape may be disadvantageous where heavy loads are to be borne by the carabiner 10 as the load is equally shared between the gate side and the spine 12. In another embodiment, the carabiner 10 may be provided to have a D-shape, where it is preferable to move the force onto the spine 12 of the carabiner 10. Similarly, the carabiner 10 may be provided as an offset-D, providing a larger gate 36, allowing a user to open the gate 36 further and more easily clip items to the carabiner 10. In still another embodiment, the carabiner 10 may be pear-shaped, which may resemble an oversized, offset-D shape and allows for even more articles to be secured with the carabiner 10. The carabiner 10 may also be provided in a delta-triangular shape, which permits the lower arm 24 to remain relatively straight and provides an increased ability to stand up to multi-directional forces compared with other carabiner designs. Depending upon the intended use of the carabiner 10, it is further contemplated that it may be formed to have a semicircular or square shape as well. The lower arm 24 may also be of different shapes. In one aspect, the lower arm may be provided with a circular, semi-circular, elliptical, or oval shape.

With reference to the figures, the upper arm 18 and the spine 12 are disposed at an angle with respect to one another. More specifically, the upper end portion 14 of the spine 12 and the first end portion 20 of the upper arm 18 are joined acutely with one another to form a curved apex 50 of the carabiner 10. As depicted, the upper arm 18 and the lower arm 24 are shaped to be generally linear. The lower arm 24 and the spine 12 are also disposed at an angle with respect to one another. Specifically, the lower end portion 16 of the spine 12 and the first end portion 26 of the lower arm 24 join with one another to form a curved lower interior corner 52 of the carabiner 10. While the geometries of the spine 12, upper arm 18, and lower arm 24 may be varied with respect to one another, the orientation depicted in the figures provides examples of various orientations that permit a majority of a weight supported by the lower arm 24 to be borne by the spine 12. This design consideration will tend to greatly increase the overall strength and durability of the carabiner 10.

In at least one aspect, the carabiner 10 is provided with no fixed structure disposed between the upper arm 18 and the lower arm 24 so that an open interior portion 54 is provided to the carabiner 10. It is contemplated that various aspects of the lower arm 24 are sufficient for a multitude of rope engagement uses. Accordingly, secondary fixed structures disposed within the open interior portion 54, such as rollers, brakes, and the like, are unnecessary and simply increase the complexity, weight and relative cost of the carabiner 10. Moreover, the various aspects of the lower arm 24 and their uses permit the open interior portion 54 of the carabiner 10 to be maximized for greater usability.

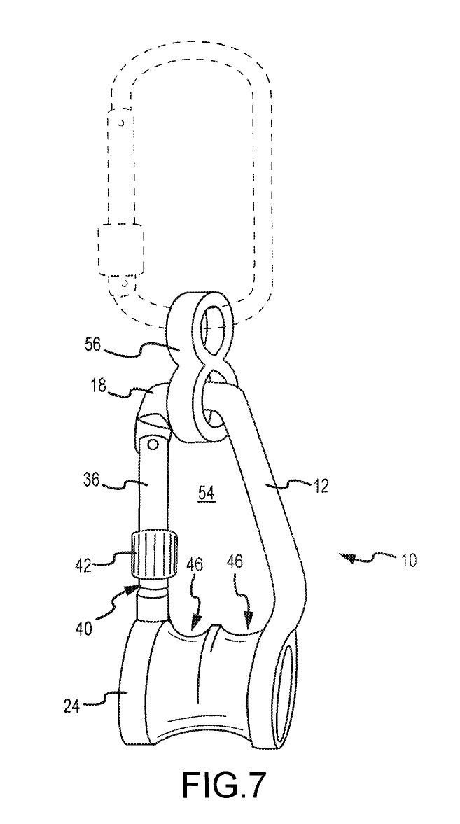

In another aspect, it is contemplated that the carabiner 10 may be used in conjunction with other equipment. With reference to FIG. 7, a webbing 56 may be used to operatively couple the carabiner 10 with another carabiner or other piece of equipment, such as an anchor and the like. While the webbing 56 is shown to have a “figure eight” configuration, other orientations are contemplated, such as a single loop, and the like. The webbing 56 may also be formed from nearly any material suitable for its intended use and may include metals such as aluminum and steel or one of various polymers.

Although the above embodiments have been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

What is claimed is:

1. A carabiner, comprising:
a spine having upper and lower end portions;
an upper arm having opposite first and second end portions; the first end portion of said upper arm being coupled with the upper end portion of said spine;
a lower arm having opposite first and second end portions; the first end portion of said lower arm being coupled with the lower end portion of said spine; and
a gate, positioned generally opposite said spine and having upper and lower end portions; said gate being selectively movable between open and closed positions;
said lower arm having a cross-sectional diameter that is larger than a cross-sectional diameter of said spine.

2. The carabiner of claim 1 wherein said lower arm has a cross-sectional diameter that is larger than a cross-sectional diameter of said upper arm.

3. The carabiner of claim 1 wherein said lower arm is provided with an open interior portion, extending along a long axis of said lower arm.

4. The carabiner of claim 1 wherein said lower arm is provided with a concave profile that is oriented to face toward said upper arm.

5. The carabiner of claim 4 wherein said concave profile extends in an annular fashion about a circumference of said lower arm.

6. The carabiner of claim 1 wherein said lower arm is provided with a profile having a plurality of concave portions, positioned adjacent one another and oriented to face toward said upper arm.

7. The carabiner of claim 6 wherein the concave portions of said profile extend in an annular fashion about a circumference of said lower arm.

8. The carabiner of claim 7 wherein said concave portions of said profile are shaped and sized to provide running grooves for one or more ropes.

9. The carabiner of claim 1 wherein said upper arm and said spine are disposed at an angle with respect to one another and the upper end portion of said spine and the first end portion of said upper arm join one another to form a curved apex of the carabiner.

10. The carabiner of claim 9 wherein said upper and lower arms are shaped to be generally straight.

11. The carabiner of claim 10 wherein said lower arm and said spine are disposed at an angle with respect to one another and the lower end portion of said spine and the first end portion of said lower arm join one another to form a curved lower interior corner of the carabiner.

12. The carabiner of claim 11 wherein said upper arm, lower arm and spine are oriented with respect to one another such that a majority of a weight supported by said lower arm is borne by said spine.

13. The carabiner of claim 11 wherein no structure is fixedly disposed between said upper arm and said lower arm, providing an open interior portion of the carabiner.

14. A carabiner, comprising:
a generally C-shaped body that includes an elongated spine, an elongated upper arm, and an elongated lower arm; said C-shaped body having first and second free ends separated by a gap; and
a gate, positioned generally opposite said spine and provided to be selectively movable between open and closed positions;
said lower arm having a generally curved shaped and having a cross-sectional diameter that is larger than a cross-sectional diameter of said spine.

15. The carabiner of claim 14 wherein said lower arm is provided to be in a fixed positional relationship with said spine and shaped to have at least one running groove that is shaped and sized to receive a length of rope.

16. The carabiner of claim 14 wherein said lower arm is provided with an open interior portion, extending along a long axis of said lower arm.
